(19) United States
(12) Patent Application Publication
(10) Pub. No.: US 2021/0334788 A1
(43) Pub. Date: Oct. 28, 2021

(54) SERVER, WALLET SYSTEM, COMPUTER READABLE RECORDING MEDIUM AND NOTIFICATION METHOD

(71) Applicant: TOYOTA JIDOSHA KABUSHIKI KAISHA, Toyota-shi (JP)

(72) Inventors: Kenji OKAZAKI, Toyota-shi (JP); Masato ENDO, Chofu-shi (JP); Mayumi KURITA, Shinjuku-ku (JP); Masashi TORITANI, Minato-ku (JP); Kumiko MATSUURA, Koto-ku (JP); Takayuki SHIKODA, Ota-ku (JP); Masaaki OTSUKA, Kawasaki-shi (JP); Yoshikazu ISHII, Nagoya-shi (JP)

(73) Assignee: TOYOTA JIDOSHA KABUSHIKI KAISHA, Toyota-shi (JP)

(21) Appl. No.: 17/215,041

(22) Filed: Mar. 29, 2021

(30) Foreign Application Priority Data
Apr. 22, 2020 (JP) 2020-076227

(51) Int. Cl. G06Q 20/36; G06Q 20/22; G06Q 20/32; G06Q 20/40

(52) U.S. Cl. CPC G06Q 20/363; G06Q 20/40; G06Q 20/3274; G06Q 20/227

(57) ABSTRACT

A server includes a processor including hardware, the processor being configured to: acquire position information of a store where a user enters; acquire store information in which store position information of each of a plurality of stores, one or more settlement methods available in each of the plurality of stores, and one or more point methods available in each of the plurality of stores are associated; generate a settlement image including the settlement method and the point method available in the store where the user enters based on the position information and the store information; and output the settlement image to a terminal owned by the user.

The present application claims priority to and incorporates by reference the entire contents of Japanese Patent Application No. 2020-076227 filed in Japan on Apr. 22, 2020.

### BACKGROUND

The present disclosure relates to a server, a wallet system, a computer readable recording medium and a notification method.

JP 2019-3508 A discloses a technique in which point use processing is performed by displaying point card information to be used by a user on a mobile phone by a QR code (registered trademark) from a plurality of pieces of point card information registered by the user of the mobile phone, and reading the QR code by a member store terminal.

### SUMMARY

Incidentally, in recent years, a user performs settlement processing of a product by a settlement method in which a two-dimensional code is displayed on a mobile terminal. Thus, when a user uses both points and a settlement method, it takes time and effort for the user to switch between display of the settlement method and display of point card information, which are displayed on a mobile phone.

There is a need for a server, a wallet system, a computer readable recording medium, and a notification method that save time and effort of a user.

According to one aspect of the present disclosure, there is provided a server including a processor including hardware, the processor being configured to: acquire position information of a store where a user enters; acquire store information in which store position information of each of a plurality of stores, one or more settlement methods available in each of the plurality of stores, and one or more point methods available in each of the plurality of stores are associated; generate a settlement image including the settlement method and the point method available in the store where the user enters based on the position information and the store information; and output the settlement image to a terminal owned by the user.

### BRIEF DESCRIPTION OF THE DRAWINGS

FIG. 1 is a diagram schematically illustrating a configuration of a wallet system according to an embodiment;

FIG. 2 is a block diagram illustrating details of each component of the wallet system according to the embodiment;

FIG. 3 is a flowchart illustrating an outline of processing executed by a wallet server according to the embodiment;

FIG. 4 is a diagram illustrating an example of an image displayed on a user terminal according to the embodiment;

FIG. 5 is a diagram illustrating an example of an image displayed on the user terminal according to the embodiment;

FIG. 6 is a flowchart illustrating an outline of processing executed by the wallet server according to a first modification of the embodiment;

FIG. 7 is a flowchart illustrating an outline of processing executed by the wallet server according to a second modification of the embodiment; and

FIG. 8 is a diagram illustrating an example of an image displayed on the user terminal according to the second modification of the embodiment.

### DETAILED DESCRIPTION

Hereinafter, a wallet system including a store terminal according to an embodiment of the present disclosure will be described with reference to the drawings. Note that the present disclosure is not limited by the embodiment described below.

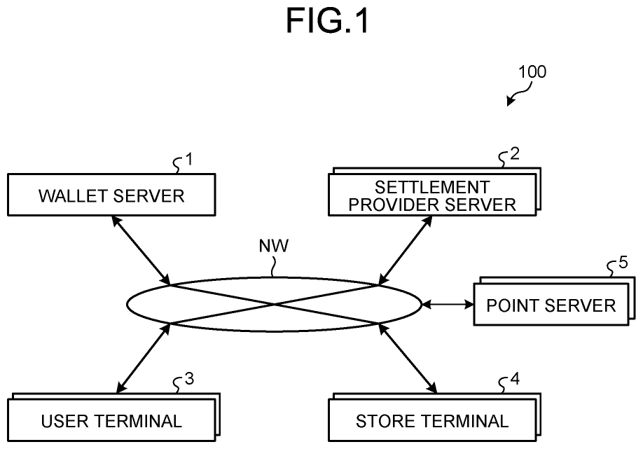

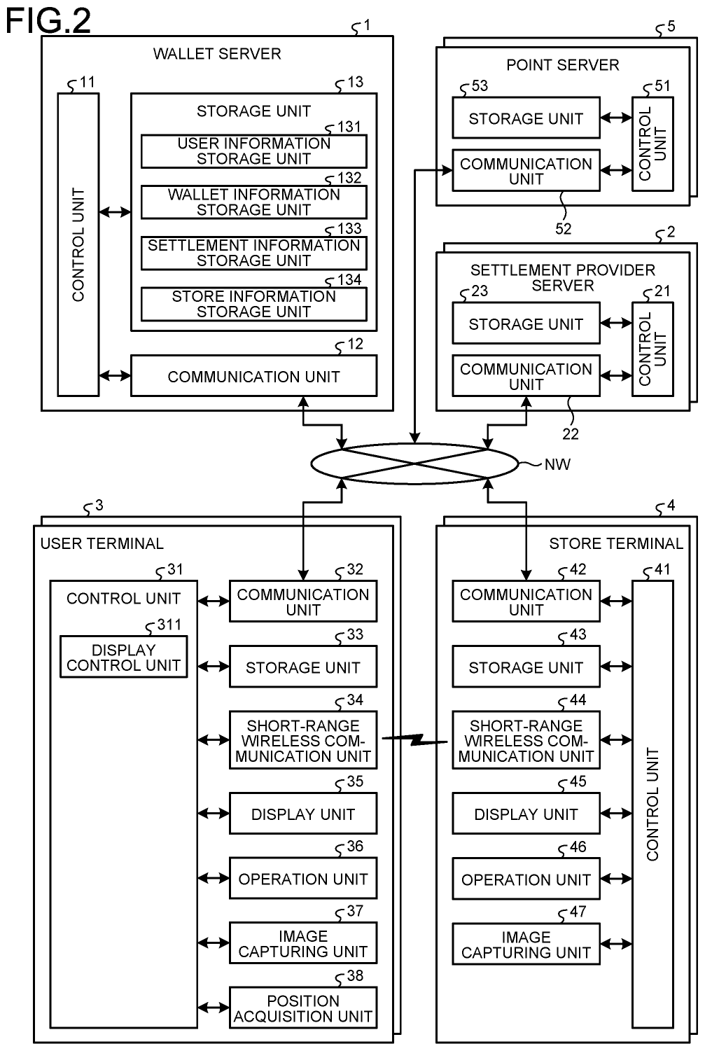

FIG. 1 is a diagram schematically illustrating a configuration of the wallet system according to the embodiment. FIG. 2 is a block diagram illustrating details of each component of the wallet system according to the embodiment. A wallet system 100 illustrated in FIGS. 1 and 2 includes a wallet server 1, a settlement provider server 2, a user terminal 3, a store terminal 4, and a point server 5. In the wallet system 100, the wallet server 1, the settlement provider server 2, the user terminal 3, the store terminal 4, and the point server 5 are able to communicate with each other through a network NW. The network NW includes, for example, an internet line network and a mobile phone line network.

First, a configuration of the wallet server 1 will be described. The wallet server 1 is a server for comprehensively managing the wallet system 100. The wallet server 1 includes a control unit 11 (second processor), a communication unit 12, and a storage unit 13.

The control unit 11 controls each unit that constitutes the wallet server 1. The control unit 11 includes a processor having hardware, such as a central processing unit (CPU) and a field-programmable gate array (FPGA), and a memory (main storage unit) including a random access memory (RAM) and a read only memory (ROM). The control unit 11 loads a program stored in the storage unit 13 into a work area of the main storage unit, executes the program, and controls each unit through the execution of the program.

The communication unit 12 is connected to the network NW such as the Internet serving as a public communication network, and communicates with each of the settlement provider server 2, the user terminal 3, and the store terminal 4 via the network NW. The communication unit 12 is implemented by using, for example, a local area network (LAN) interface board or a wireless communication circuit for wireless communication.

The storage unit 13 stores various programs executed by the wallet server 1. The storage unit 13 is implemented by using a hard disk drive (HDD), a solid state drive (SSD), and the like. In addition, the storage unit 13 includes a user information storage unit 131 for each user using the wallet system 100, a wallet information storage unit 132, a settlement information storage unit 133, and a store information storage unit 134 (memory).

The user information storage unit 131 stores user information regarding a user who uses the wallet system 100. Examples of the user information include a user ID of the user who has registered to use the wallet system 100, a password, a name of the user, contact information (for example, address, phone number, and email address) of the user, terminal information (IP address) of the user, registration history information, history information of a plurality of settlement methods, information regarding a payment method registered as a depositing method, registration information indicating the plurality of settlement methods (names of settlement applications) registered as settlement methods of the user terminal 3, and a personal identification number at the time of settlement. Furthermore, the user information includes information in which a plurality of point methods registered by the user, the plurality of settlement methods, and use histories of the plurality of settlement methods are associated with the user terminal 3 (IP address). Furthermore, the user information includes the plurality of settlement methods, the use histories of the plurality of settlement methods, the plurality of point methods registered by the user, and a point balance of the user associated with the user terminal 3 (IP address) in each of the plurality of point methods. Note that, in the user information storage unit 131, the user ID and the password are used for authentication processing such as login to the wallet server 1.

The wallet information storage unit 132 stores wallet information regarding a wallet of the wallet system 100. The wallet is a virtual deposit/withdrawal account of electronic money. Specifically, examples of the wallet information include a user ID, a balance of electronic money, a deposit history of electronic money, and a use history of electronic money.

The settlement information storage unit 133 stores settlement information regarding settlement of the wallet system 100. The settlement information includes a user ID, a settlement method used for settlement (for example, electronic money payment (contactless payment), scan payment, and code payment), a settlement history, and history information of the plurality of settlement methods.

The store information storage unit 134 stores store information in which store position information of each of a plurality of stores, one or more settlement methods available in each of the plurality of stores, one or more point methods available in each of a plurality of stores, budget information indicating a budget of each of the plurality of stores, and vendor information indicating a vendor (for example, a convenience store and a general store) of each of the plurality of stores are associated. Note that the store information storage unit 134 may store a store name, a service period, a phone number, and the like in addition to the store position information (address).

Next, a configuration of the settlement provider server 2 will be described. The settlement provider server 2 is a server for managing an account and a credit card of the user. The settlement provider server 2 is provided in a financial institution (for example, a bank, a credit union, a credit association, and a labor bank) and a credit card company. The settlement provider server 2 includes a control unit 21, a communication unit 22, and a storage unit 23. Since the control unit 21, the communication unit 22, and the storage unit 23 have functions similar to those of the control unit 11, the communication unit 12, and the storage unit 13, detailed description thereof will be omitted.

The storage unit 23 stores account information and credit card information, for each user of the wallet system 100. Examples of the account information include a name of the user, an account number, an account balance, and a deposit/withdrawal history. In addition, examples of the credit card information include a name of the user, a credit card number, an expiration date of the credit card, use limit amount, and a card use history.

Next, a configuration of the user terminal 3 will be described. Examples of the user terminal 3 include a smartphone, a mobile phone, a tablet terminal, a wearable computer, a personal computer, and a car navigation system mounted on a vehicle, which are owned by the user. The user terminal 3 may be any terminal as long as information may exchanged with the wallet server 1.

The user terminal 3 includes a control unit 31 (first processor), a communication unit 32, a storage unit 33, a short-range wireless communication unit 34, a display unit 35, an operation unit 36, an image capturing unit 37, and a position acquisition unit 38. Since the communication unit 32 has a function similar to that of the communication unit 12, detailed description thereof will be omitted.

The control unit 31 controls each unit that constitutes the user terminal 3. The control unit 31 includes a processor having hardware, such as a CPU and a DSP, and a memory (main storage unit) including a RAM and a ROM. The control unit 31 loads a program stored in the storage unit 33 into a work area of the main storage unit, executes the program, and controls each unit through the execution of the program. The control unit 31 functions as a display control unit 311 through the execution of the program.

The display control unit 311 controls display contents on the display unit 35. Based on selection operation of the user (touch operation, slide operation, pinch operation, flick operation, and the like) for the operation unit 36, the display control unit 311 displays, on the display unit 35, a member registration screen for the user to register as a member, a login screen for the user to log in to the wallet system 100, a depositing screen for the user to deposit electronic money into the wallet, a settlement screen for the user to perform settlement, and the like. The display control unit 311 also performs transition of each screen or image based on operation of the user.

The storage unit 33 stores data of various screens to be displayed by the display control unit 311 on the display unit 35. The storage unit 33 is implemented by using an HDD, an SSD, or the like. The storage unit 33 includes a user information storage unit 131, a wallet information storage unit 132, a settlement information storage unit 133, and a store information storage unit 134, as needed.

The short-range wireless communication unit 34 has a communication function conforming to a standard such as near field radio communication (NFC), Bluetooth (registered trademark) low energy (BLE), or Infrared Data Association (IrDA), for example. For example, when performing electronic money payment, the user terminal 3 performs short-range wireless communication with the store terminal 4 through the short-range wireless communication unit 34.

The display unit 35 is implemented by using a liquid crystal display, an organic electroluminescent display (organic EL display), or the like, and displays various types of information and images under the control of the control unit 31.

The operation unit 36 is implemented by using a touch panel, a button, a switch, and the like, receives operation by the user, and outputs contents corresponding to the received operation to the control unit 31.

The image capturing unit 37 captures an image of a predetermined field of view and outputs the captured image (image data) to the control unit 31. The image capturing unit 37 is implemented by using one or more lenses and an image sensor such as a charge coupled device (CCD) sensor or a complementary metal oxide semiconductor (CMOS) sensor.

The position acquisition unit 38 acquires position information regarding a current position of the user terminal 3 and outputs the acquired position information to the control unit 31. The position acquisition unit 38 is implemented by using a GPS sensor, receives signals from a plurality of GPS satellites and transmission antennas, and acquires the position information of the user terminal 3 based on the received signals.

Next, a configuration of the store terminal 4 will be described. The store terminal 4 is provided in a store (member store) where the wallet system 100 may be used.

The store terminal 4 includes a control unit 41, a communication unit 42, a storage unit 43, a short-range wireless communication unit 44, a display unit 45, an operation unit 46, and an image capturing unit 47. Since the control unit 41, the communication unit 42, the storage unit 43, the short-range wireless communication unit 44, the display unit 45, the operation unit 46, and the image capturing unit 47 have functional configurations similar to those of the control unit 31, the communication unit 32, the storage unit 33, the short-range wireless communication unit 34, the display unit 35, the operation unit 36, and the image capturing unit 37, detailed description thereof will be omitted.

Next, a configuration of the point server 5 will be described. The point server 5 is a server for managing points of the point method to which each of the plurality of stores is affiliated. The point server 5 includes a control unit 51, a communication unit 52, and a storage unit 53. Since the control unit 51, the communication unit 52, and the storage unit 53 have functions and configurations similar to those of the control unit 11, the communication unit 12, and the storage unit 13, detailed description thereof will be omitted. Note that the storage unit 53 stores terminal information (IP address) of the user terminal 3 of the user and a point balance of the user associated with the user terminal 3 in association with each other.

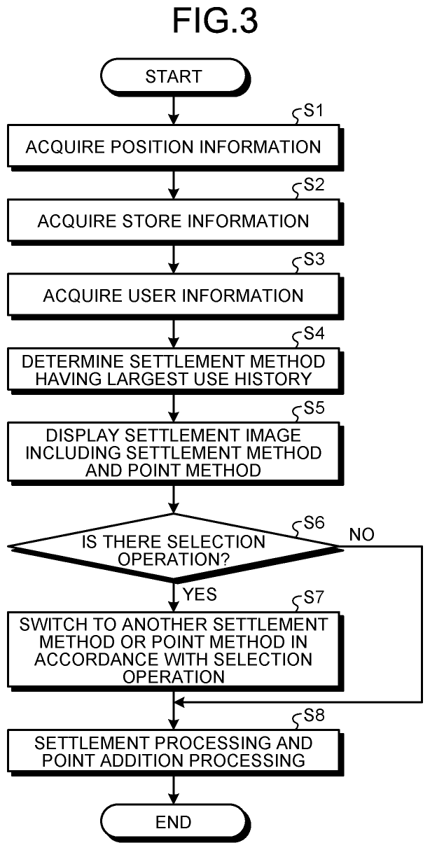

Next, processing executed by the wallet server 1 will be described. FIG. 3 is a flowchart illustrating an outline of the processing executed by the wallet server 1.

As illustrated in FIG. 3, first, the control unit 11 acquires position information of a store where a user has entered, which is input by the user via the user terminal 3 (Step S1). Specifically, the control unit 11 acquires position information of the user terminal 3 acquired by the user by the position acquisition unit 38 of the user terminal 3. In this case, the control unit 11 acquires, from the user terminal 3, terminal information (IP address) of the user terminal 3. Note that the control unit 11 may acquire, as the position information, an address input and specified by the user via the operation unit 36 of the user terminal 3. Furthermore, the control unit 11 may acquire, as the position information, information read by the image capturing unit 37 of the user terminal 3 from a two-dimensional code (for example, QR code (registered trademark)) indicating position information, which is provided in the store where the user has entered.

Subsequently, the control unit 11 acquires store information stored in the store information storage unit 134 (Step S2), and acquires user information stored in the user information storage unit 131 (Step S3).

Thereafter, the control unit 11 determines a settlement method having the largest use history of the user based on device information of the user terminal 3 and user information associated with the device information (Step S4).

Subsequently, the control unit 11 displays, on one screen of the display unit 35 of the user terminal 3, a settlement image including a settlement method and a point method available in the store where the user has entered based on the settlement method having the largest use history of the user determined in Step S4, the position information acquired from the user terminal 3, and the store information based on the position information (Step S5).

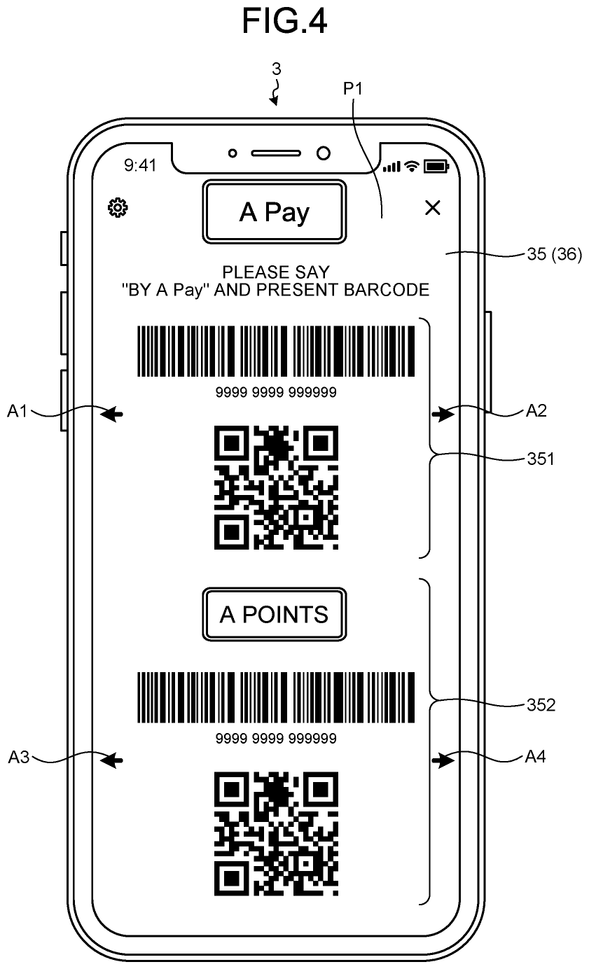

FIG. 4 is a diagram illustrating an example of an image displayed on the user terminal 3. As illustrated in FIG. 4, the user terminal 3 displays a settlement image P1 including a settlement method and a point method output from the wallet server 1 under the control of the display control unit 311. Specifically, as illustrated in FIG. 4, the settlement image P1 includes a settlement screen 351 by [A Pay], which is the settlement method having the largest use history of the user, and a point screen 352 of the point method available in the store where the user has entered. The settlement image P1 also includes icons A1 and A2 for switching to the next settlement method available in the store where the user has entered and icons A3 and A4 for switching to the next point method available in the store where the user has entered.

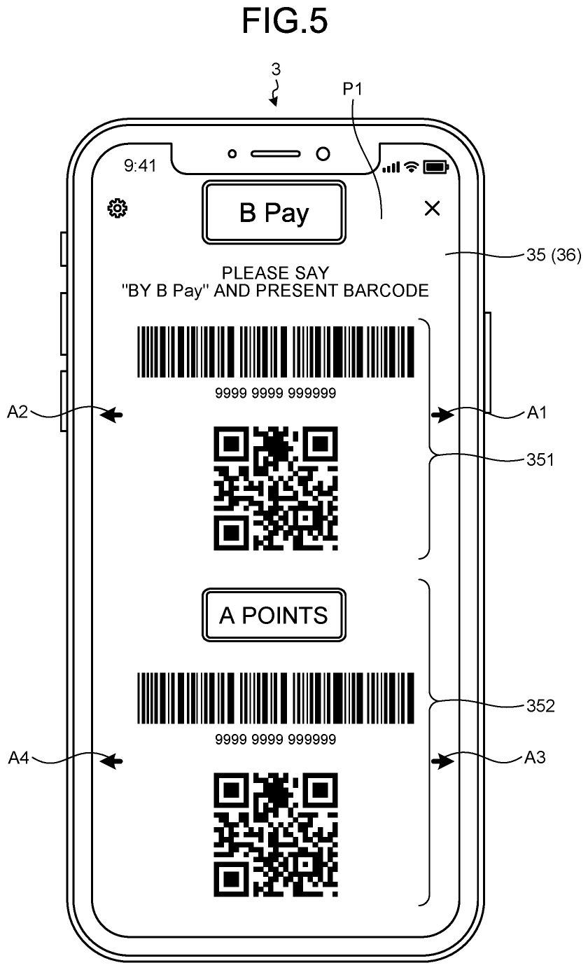

Thereafter, when there is selection operation (for example, slide operation) by the user for the settlement image P1 displayed on the display unit 35 of the user terminal 3 (Step S6: Yes), the control unit 11 switches the settlement method or the point method of the settlement image P1 to another settlement method or another point method in accordance with the selection operation (Step S7). For example, when the user performs a slide operation for switching the settlement method, as illustrated in FIG. 5, the control unit 11 switches the settlement method of the settlement image P1 from [A Pay] to [B Pay], and displays [B Pay] on the display unit 35 of the user terminal 3. After Step S7, the wallet server 1 proceeds to Step S8 to be described later. On the other hand, when there is no selection operation by the user for the settlement image P1 displayed on the display unit 35 of the user terminal 3 (Step S6: No), the wallet server 1 proceeds to Step S8 to be described later.

Subsequently, when a product is settled in the store where the user has entered, the control unit 11 executes settlement processing and point addition processing (Step S8). Specifically, the control unit 11 performs settlement processing for outputting, based on settlement information of the settlement method read by the image capturing unit 47 of the store terminal 4, the settlement information to the settlement provider server 2, and for subtracting a price of the product from a deposit of the user stored in the wallet information storage unit 132. Furthermore, the control unit 11 performs the point addition processing for outputting, based on point information of the point method read by the image capturing unit 47 of the store terminal 4, the point information to the point server 5, and for adding points corresponding to purchase of the product to points of the point method stored in the user information storage unit 131. After Step S8, the wallet server 1 ends this processing.

According to the embodiment described above, the control unit 11 generates and outputs, based on position information of a store where a user has entered and store information stored in the store information storage unit 134, a settlement image including a settlement method and a point method available in the store where the user has entered, and thereby displays the settlement image on a screen of the display unit 35 of the user terminal 3 owned by the user. Thus, the user does not need to switch between the settlement method and the point method each time, so that the user may save time and effort caused in the settlement processing and point processing.

In addition, according to the embodiment, based on a use history of each of a plurality of settlement methods by the user, the control unit 11 displays, on the display unit 35 of the user terminal 3, a settlement method having the largest use history from the plurality of settlement methods in the store where the user has entered. Thus, the user may save time and effort for processing of selecting a desired settlement method from the plurality of settlement methods.

In addition, according to the embodiment, the control unit 11 displays one of the settlement method and the point method in an upper area of the screen of the display unit 35 of the user terminal 3, and displays the other of the settlement method and the point method in a lower area. Thus, the user may confirm the settlement method and the point method at once.

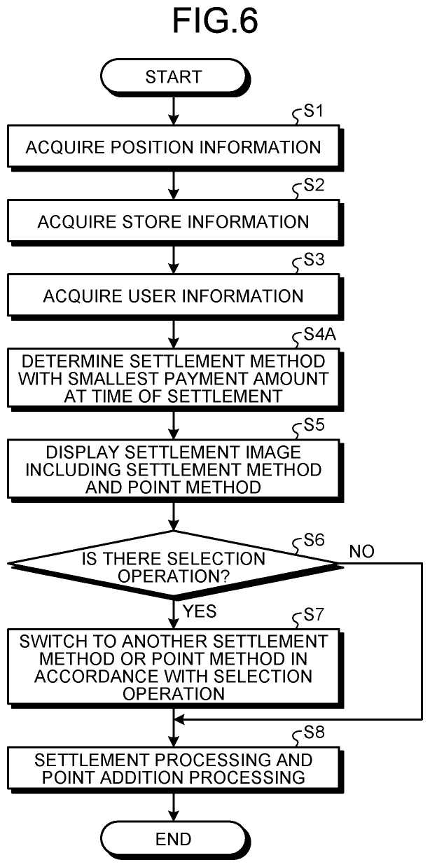

Next, a first modification of the embodiment will be described. FIG. 6 is a flowchart illustrating an outline of processing executed by the wallet server 1 according to the first modification of the embodiment. In FIG. 6, Step S4A is executed instead of Step S4 of FIG. 3, and since other steps are similar to steps of FIG. 3, detailed description thereof will be omitted.

In Step S4A, when settlement is possible by using a plurality of settlement methods, the control unit 11 determines a settlement method with the smallest payment amount at the time of settlement of a product from the plurality of settlement methods based on a point balance of a point method available in the store where the user has entered. Note that, when settlement is possible by using a plurality of settlement methods, the control unit 11 may determine a settlement method with the smallest payment amount at the time of settlement of a product from the plurality of settlement methods based on a discount rate with a coupon available in the store where the user has entered. After Step S4A, the wallet server 1 proceeds to Step S5.

According to the first modification of the embodiment described above, when settlement is possible by using a plurality of settlement methods, the control unit 11 determines, as a selection result, a settlement method with the smallest payment amount at the time of settlement of a product from the plurality of settlement methods based on a point balance of a point method available in a store where a user has entered. Thus, the user may settle the product by the most advantageous settlement method.

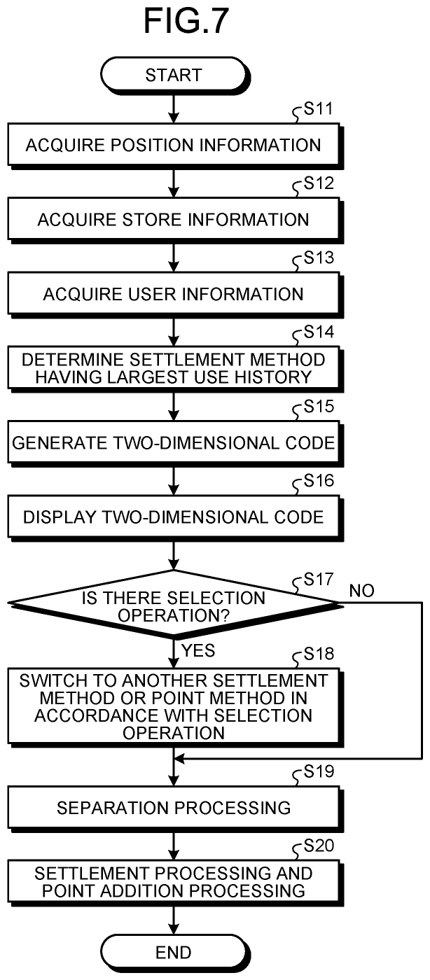

Next, a second modification of the embodiment will be described. FIG. 7 is a flowchart illustrating an outline of processing executed by the wallet server 1 according to the second modification of the embodiment. In FIG. 7, since Steps S11 to S14, and Steps S17 to S18 and Step S20 correspond to Steps S1 to S4 and Steps S6 to S8 of FIG. 3, respectively, detailed description thereof will be omitted.

In Step S15, the control unit 11 generates a two-dimensional code including information regarding a settlement method and information regarding a point method available in the store where the user has entered.

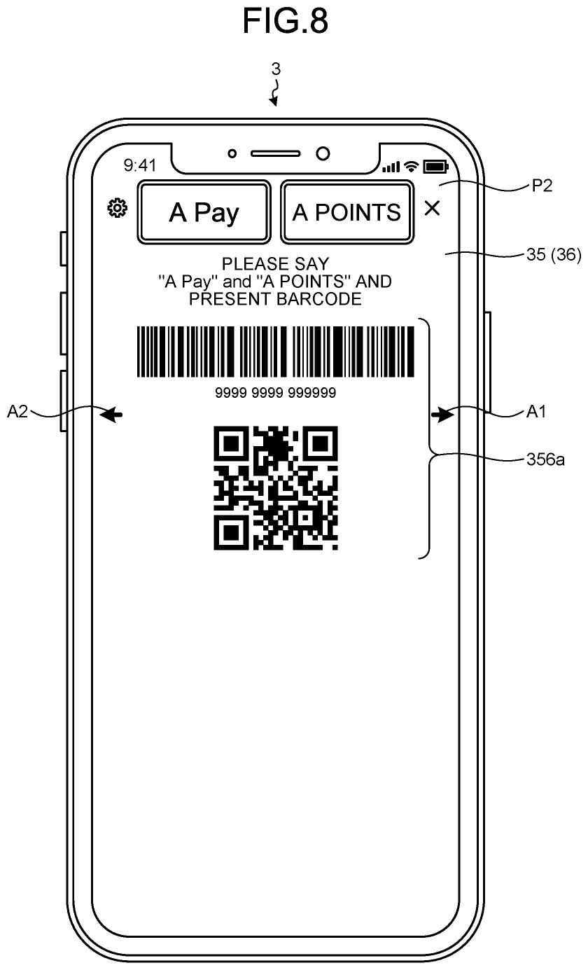

Subsequently, the control unit 11 displays the two-dimensional code on the display unit 35 of the user terminal 3 (Step S16). Specifically, as illustrated in FIG. 8, the control unit 11 displays, on the display unit 35 of the user terminal 3, a settlement image P2 including code information (for example, a QR code as the two-dimensional code or a one-dimensional code) including the information regarding the settlement method and the information regarding the point method available in the store where the user has entered. Thus, the user may present the settlement method and the point method only by displaying one two-dimensional code. After Step S16, the wallet server 1 proceeds to Step S17.

In Step S19, the control unit 11 performs separation processing for separating the type of the settlement method and the type of the point method from the two-dimensional code read by the image capturing unit 37 of the user terminal 3. After Step S19, the wallet server 1 ends this processing.

In addition, in the wallet system according to the embodiment, “unit” may be read as “circuit” or the like. For example, the control unit may be read as a control circuit.

In addition, a program executed by the wallet system according to the embodiment is provided as file data in an installable format or an executable format recorded on a computer-readable recording medium such as a CD-ROM, a flexible disk (FD), a CD-R, a digital versatile disk (DVD), a USB medium, or a flash memory.

In addition, the program executed by the wallet system according to the embodiment may be stored in a computer connected to a network such as the Internet and downloaded via the network to be provided.

Note that, in the description of the flowcharts in the present specification, expressions such as “first”, “thereafter”, and “subsequently” are used to clarify a relationship between processing of preceding and following steps, but the order of processing to implement the present embodiment is not uniquely determined by such expressions. That is, the order of processing in the flowcharts described in the present specification may be changed to the extent that no inconsistency occurs.

According to the present disclosure, there is an effect that time and effort of a user may be saved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising
a processor comprising hardware, the processor being configured to:
acquire position information of a store where a user enters;
acquire store information in which store position information of each of a plurality of stores, one or more settlement methods available in each of the plurality of stores, and one or more point methods available in each of the plurality of stores are associated;
generate a settlement image including the settlement method and the point method available in the store where the user enters based on the position information and the store information; and
output the settlement image to a terminal owned by the user.

2. The server according to claim 1, wherein the processor is configured to:
acquire user information in which a plurality of point methods registered by the user, a plurality of settlement methods, and use histories of the plurality of settlement methods are associated with the terminal; and
generate the settlement image by using a settlement method having a largest use history from the plurality of settlement methods available in the store where the user enters based on the user information.

3. The server according to claim 1, w wherein the processor is configured to:
acquire user information in which a plurality of settlement methods, use histories of the plurality of settlement methods, a plurality of point methods registered by the user, and a point balance of the user associated with the terminal in each of the plurality of point methods are associated; and
when settlement by using the plurality of settlement methods is possible in the store where the user enters, generate the settlement image by using a settlement method with a smallest payment amount at a time of settlement of a product from the plurality of settlement methods based on a point balance of the point method available in the store where the user enters.

4. The server according to claim 1, wherein when selection operation is performed on the settlement method or the point method of the settlement image displayed on a display of the terminal, the processor is configured to switch the settlement method or the point method to another settlement method or point method.

5. The server according to claim 1, wherein the processor is configured to:
display one of the settlement method and the point method in an upper area of the settlement image; and
display another one of the settlement method and the point method in a lower area of the settlement image.

6. The server according to claim 1, wherein the settlement image is code information including information regarding the settlement method and information regarding the point method, the settlement method and the point method being available in the store where the user enters.

7. The server according to claim 6, wherein the processor is configured to:
acquire the code information;
separate the information regarding the settlement method and the information regarding the point method included in the code information;
output the information regarding the settlement method to a settlement server; and
output the information regarding the point method to a point server.

8. A wallet system comprising:
a terminal comprising a first processor comprising hardware, the first processor being configured to
acquire position information of a store where a user enters; and
a server comprising a second processor comprising hardware, the second processor being configured to
acquire the position information,
acquire store information in which store position information of each of a plurality of stores, one or more settlement methods available in each of the plurality of stores, and one or more point methods available in each of the plurality of stores are associated,
generate a settlement image including the settlement method and the point method available in the store where the user enters based on the position information and the store information, and
output the settlement image to a terminal owned by the user.

9. The wallet system according to claim 8, wherein the second processor is configured to:
acquire user information in which a plurality of point methods registered by the user, a plurality of settlement methods, and use histories of the plurality of settlement methods are associated with the terminal; and
generate the settlement image by using a settlement method having a largest use history from the plurality of available settlement methods in the store where the user enters based on the user information.

10. The wallet system according to claim 8, wherein the second processor is configured to:
acquire user information in which a plurality of settlement methods, use histories of the plurality of settlement methods, a plurality of point methods registered by the user, and a point balance of the user associated with the terminal in each of the plurality of point methods are associated; and
when settlement by using the plurality of settlement methods is possible in the store where the user enters, generate the settlement image by using a settlement method with a smallest payment amount at a time of settlement of a product from the plurality of settlement methods based on a point balance of the point method available in the store where the user enters.

11. The wallet system according to claim 8, wherein when selection operation is performed on the settlement method or the point method of the settlement image displayed on a display of the terminal, the second processor is configured to switch the settlement method or the point method to another settlement method or point method.

12. The wallet system according to claim 8, wherein the second processor is configured to:
display one of the settlement method and the point method in an upper area of the settlement image; and
display another one of the settlement method and the point method in a lower area of the settlement image.

13. The wallet system according to claim 8, wherein the settlement image is code information including information regarding the settlement method and information regarding the point method, the settlement method and the point method being available in the store where the user enters.

14. The wallet system according to claim 13, wherein the second processor is configured to:
acquire the code information;
separate the information regarding the settlement method and the information regarding the point method included in the code information;
output the information regarding the settlement method to a settlement server; and
output the information regarding the point method to a point server.

15. A non-transitory computer-readable recording medium on which an executable program is recorded, the program causing a processor of a computer to execute:
acquiring position information of a store where a user enters;
acquiring store information in which store position information of each of a plurality of stores, one or more settlement methods available in each of the plurality of stores, and one or more point methods available in each of the plurality of stores are associated;
generating a settlement image including the settlement method and the point method available in the store where the user enters based on the position information and the store information; and
outputting the settlement image to a terminal owned by the user.

16. The non-transitory computer-readable recording medium according to claim 15, wherein the program causes the processor to execute:
acquiring user information in which a plurality of point methods registered by the user, a plurality of settlement methods, and use histories of the plurality of settlement methods are associated with the terminal; and
generating the settlement image by using a settlement method having a largest use history from the plurality of available settlement methods in the store where the user enters based on the user information.

17. The non-transitory computer-readable recording medium according to claim 15, wherein the program causes the processor to execute:
acquiring user information in which a plurality of settlement methods, use histories of the plurality of settlement methods, a plurality of point methods registered by the user, and a point balance of the user associated with the terminal in each of the plurality of point methods are associated; and
when settlement by using the plurality of settlement methods is possible in the store where the user enters, generating the settlement image by using a settlement method with a smallest payment amount at a time of settlement of a product from the plurality of settlement methods based on a point balance of the point method available in the store where the user enters.

18. The non-transitory computer-readable recording medium according to claim 15, wherein the program causes the processor to execute, when selection operation is performed on the settlement method or the point method of the settlement image displayed on a display of the terminal, switching the settlement method or the point method to another settlement method or point method.

19. The non-transitory computer-readable recording medium according to claim 15, wherein the program causes the processor to execute:
displaying one of the settlement method and the point method in an upper area of the settlement image; and
displaying another one of the settlement method and the point method in a lower area of the settlement image.

20. A method of notifying, the method comprising:
acquiring position information of a store where a user enters;
acquiring store information in which store position information of each of a plurality of stores, one or more settlement methods available in each of the plurality of stores, and one or more point methods available in each of the plurality of stores are associated;
generating a settlement image including the settlement method and the point method available in the store where the user enters based on the position information and the store information; and
outputting the settlement image to a terminal owned by the user.
